(19) United States
(12) Patent Application Publication
(10) Pub. No.: US 2026/0033439 A1
(43) Pub. Date: Feb. 5, 2026

(54) MODULAR GROW HOUSE SYSTEM WITH AUTOMATED ENVIRONMENTAL CONTROL FOR VEGETATION CULTIVATION

(71) Applicant: Joshua D. Smith, Louisville, KY (US)

(72) Inventor: Joshua D. Smith, Louisville, KY (US)

(21) Appl. No.: 18/795,073

(22) Filed: Aug. 5, 2024

Related U.S. Application Data
(60) Provisional application No. 63/578,453, filed on Aug. 24, 2023.

(51) Int. Cl. A01G 9/24; G05B 19/418; G05B 23/02

(52) U.S. Cl. CPC A01G 9/246; A01G 9/247; A01G 9/249; G05B 19/41845; G05B 23/0272

(57) ABSTRACT

The present invention relates to a modular grow house system designed for optimizing the cultivation of various vegetation types through advanced environmental control. The system comprises multiple grow chambers, each equipped with sensors to monitor temperature, humidity, light, and soil moisture, and actuators to regulate these conditions. A central control unit, including receiving, monitoring, processing, and regulating units, manages the environmental conditions based on plant profiles stored in digital formats like JSON, XML, or CSV. The modular design features interchangeable panels, standardized sensor and actuator mounts, and quick-connect fittings, allowing flexible configuration and expansion. Safety features, such as temperature and humidity alarms, and a user interface for manual control, enhance the system's functionality. Additionally, the control unit supports remote updates via a cloud platform, ensuring up-to-date plant profiles and control algorithms. This invention provides a scalable, automated solution for controlled environment agriculture, improving productivity and sustainability in various settings.

### TECHNICAL FIELD

The present invention relates to the field of agricultural technology and horticulture. More specifically, it pertains to a modular grow house system equipped with advanced sensors, actuators, and a centralized control unit for the automated monitoring and regulation of environmental conditions to optimize the growth and cultivation of various types of vegetation in controlled environments.

### BACKGROUND OF THE INVENTION

The agricultural sector has always been vital to human civilization, providing essential resources such as food, fiber, and fuel. However, traditional agricultural practices face numerous challenges, including unpredictable weather conditions, pest infestations, and the necessity for large tracts of arable land. As the global population continues to rise, the demand for food production is increasing, placing significant pressure on existing agricultural systems. To address these challenges, there has been a growing interest in controlled environment agriculture (CEA), which offers the potential to optimize plant growth conditions and improve yield efficiency.

Greenhouses represent a well-established form of CEA, allowing farmers to extend growing seasons, protect crops from adverse weather, and enhance plant growth through controlled temperature, humidity, and light conditions. However, conventional greenhouse systems have several limitations. These systems often require significant initial investments and operating costs, making them less accessible to small-scale farmers and those in low-income or urban areas. Additionally, traditional greenhouses rely heavily on manual intervention to adjust environmental parameters, which can be labor-intensive and inconsistent.

One of the primary challenges in conventional greenhouse systems is the difficulty in maintaining consistent and optimal growing conditions. Environmental factors such as temperature, humidity, light, and soil moisture are crucial for plant health and productivity, but these conditions can fluctuate widely due to external weather patterns and other uncontrollable variables. Manual adjustments to these parameters are not only labor-intensive but also prone to human error, resulting in suboptimal growth conditions and reduced crop yields. Furthermore, the lack of automation and precise control in traditional greenhouses makes it challenging to create standardized growing environments, leading to variability in crop quality and production.

Urban agriculture has emerged as a promising solution to address food security issues in densely populated areas. By growing crops closer to consumers, urban agriculture can reduce transportation costs, lower carbon emissions, and provide fresh produce to communities with limited access to healthy food options. However, implementing urban agriculture poses unique challenges. Space constraints in urban settings necessitate innovative growing solutions that maximize productivity in small areas. Additionally, urban farmers often lack the resources and expertise required to implement advanced agricultural technologies, further complicating the adoption of controlled environment systems.

Another significant issue in the current state of agricultural technology is the inefficiency of resource use. Traditional farming practices, including greenhouse cultivation, often involve substantial water, nutrient, and energy consumption. Inefficient irrigation systems can lead to water wastage, while imprecise nutrient delivery can result in over-fertilization, contributing to environmental pollution and increased costs. Energy consumption is also a critical concern, particularly in greenhouses that require artificial lighting, heating, and cooling to maintain optimal growing conditions. The high energy demands of these systems not only increase operational costs but also raise concerns about sustainability and environmental impact.

In addition to the challenges of maintaining optimal growing conditions and resource efficiency, monitoring plant health and development is another critical aspect that requires attention. Early detection of plant stress, disease, and nutrient deficiencies is essential for timely intervention and prevention of crop loss. However, traditional methods of plant monitoring often rely on visual inspection and manual data collection, which can be time-consuming and limited in scope. The lack of real-time data and automated monitoring systems hampers the ability to respond quickly to changes in plant health, potentially leading to significant yield losses.

Moreover, the integration of modern technology into agricultural practices remains a complex task. The adoption of sensors, automation, and data-driven decision-making tools is often hindered by the lack of user-friendly interfaces and the technical knowledge required to operate these systems effectively. Small-scale and urban farmers, in particular, may find it challenging to implement advanced technologies due to limited access to training and support. This technological gap limits the potential benefits of CEA and reduces the accessibility of these innovations to a broader range of growers.

Despite the advancements in agricultural technology, there is a notable gap in the availability of modular, scalable, and automated systems that can address the diverse needs of different plant species and growing environments. Existing solutions are often rigid and specialized, lacking the flexibility to accommodate various types of crops or to scale up or down based on specific requirements. The absence of modular design elements in current systems makes it difficult for growers to customize their setups or expand their operations as needed, limiting their adaptability and potential for growth.

Several prior arts have attempted to address these issues with varying degrees of success. For instance, US20210337748A1 describes an automated greenhouse system that employs sensors and actuators to control environmental conditions. While it provides some level of automation, it lacks the modularity and scalability required to adapt to different crop types and growth stages.

Similarly, US20210289716A1 discloses a system for controlled environment agriculture that includes sensors for monitoring environmental parameters and actuators for adjusting conditions. However, this system also falls short in terms of modular design and ease of customization for various plant species.

US20230172118A1 presents a method for optimizing plant growth conditions using real-time data and machine learning algorithms. This approach enhances the precision of environmental control but does not address the need for a modular and scalable system that can be easily reconfigured for different growing environments.

Lastly, US20220400628A1 introduces a smart farming system with integrated sensors and actuators for real-time monitoring and control. While this system offers advanced technological features, it still lacks the flexibility and modularity needed to support diverse agricultural applications in urban and resource-constrained settings.

These prior arts, while advancing the field of controlled environment agriculture, lack a comprehensive solution that integrates modularity with the ability to grow different types of vegetation in a single system. The lack of modularity in these systems restricts their adaptability to various plant species and growth stages, limiting their effectiveness as a one-stop solution for diverse agricultural needs. A truly effective system would combine the benefits of modular design with advanced automation and monitoring capabilities, providing a flexible, scalable, and user-friendly solution for optimizing plant growth in a wide range of environments.

The need for a more adaptable, efficient, and user-friendly system is evident. Such a system should be capable of dynamically adjusting environmental parameters to meet the specific requirements of different plant species and growth stages. It should also be resource-efficient, reducing water, nutrient, and energy consumption while minimizing environmental impact. Furthermore, the system should incorporate advanced monitoring and automation technologies to provide real-time data and facilitate precise control over growing conditions. By addressing these challenges, it would be possible to enhance the productivity and sustainability of agricultural practices, particularly in urban and resource-constrained settings.

The current state of agricultural technology presents several challenges that hinder the efficiency and accessibility of controlled environment agriculture. Traditional greenhouse systems are often costly, labor-intensive, and inconsistent in maintaining optimal growing conditions. Urban agriculture faces unique challenges related to space constraints and resource limitations. Additionally, there is a significant need for more efficient resource use, advanced monitoring systems, and user-friendly technologies to support modern agricultural practices. Addressing these issues requires innovative solutions that offer flexibility, scalability, and automation to optimize plant growth and enhance the sustainability of agricultural systems.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present invention relates to a modular grow house system designed to optimize the cultivation of various types of vegetation through advanced environmental control. This innovative system addresses the limitations of traditional greenhouses and existing controlled environment agriculture (CEA) technologies by incorporating modularity, scalability, and automation. The system comprises a plurality of grow chambers, each equipped with a set of sensors to monitor environmental conditions and a set of actuators to regulate these conditions. The sensors include temperature sensors, humidity sensors, light sensors, and soil moisture sensors, while the actuators encompass cooling fans, venting fans, water pumps, misting devices, and LED lighting fixtures. These components work together to create and maintain optimal growing environments within each chamber by dynamically adjusting environmental parameters based on plant profiles.

Central to the system is a control unit configured to manage the environmental conditions within each grow chamber. The control unit includes a receiving unit to accept plant profile information for each grow chamber, a monitoring unit to gather real-time data from the sensors within each chamber, a processing unit to determine the optimal environmental conditions for each chamber based on the plant profiles and real-time data, and a regulating unit to instruct the actuators to adjust the environmental conditions to maintain the determined optimal settings. The plant profile information is stored in a digital format, such as JSON, XML, or CSV files, within the memory module or SD card. Users input these parameters via a user interface, which communicates with a primary controller. This primary controller parses the plant parameters, correlates them to the appropriate sensor readings and actuator controls, and transmits the parsed parameters to a secondary controller, referred to as ControllerIO/Control Unit, which manages the real-time adjustments within each grow chamber.

The system is designed with modular elements that enable flexible configuration and expansion both vertically and horizontally, allowing the footprint to be mimicked and adapted based on the available space and specific needs. This includes interchangeable panels, standardized mounting brackets for sensors and actuators, quick-connect fittings for water and electrical connections, and expandable frame structures. These features allow the grow house to be easily assembled, disassembled, and reconfigured to accommodate different plant species and growing conditions.

Additionally, the system incorporates safety features, such as temperature and humidity alarms, to detect abnormal environmental conditions. It also includes a user interface that allows for manual override of the control unit, enabling direct control of the actuators. Furthermore, the control unit is configured to receive remote updates via a cloud platform, ensuring that the plant profile information and control algorithms remain up to date.

The modular grow house system also provides real-time alerts and notifications based on deviations from the optimal environmental conditions, facilitating timely interventions and adjustments. This comprehensive approach ensures that the system can independently monitor and adjust conditions within each grow chamber, supporting the simultancous cultivation of multiple types of vegetation. Overall, the present invention offers a flexible, scalable, and automated solution for controlled environment agriculture. By addressing the limitations of existing technologies, it enhances the productivity and sustainability of agricultural practices, particularly in urban and resource-constrained settings.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is a depicts an exemplary architecture of the grow house control system according to the embodiments of the present disclosure.

FIG. 2 is an exemplary process flow diagram of the system managing the grow house system according to the embodiments of the present disclosure.

FIG. 3 is an exemplary control flow diagram between the primary components of the grow house system according to the embodiments of the present disclosure.

FIG. 4 is a perspective view of the modular grow house system, showing the overall design and structure, including the roof panel, side panels, doors, handles, and aluminum extrusions according to the embodiments of the present disclosure.

FIG. 5 is a section view of the modular grow house system taken along line 2-2 of FIG. 4 according to the embodiments of the present disclosure.

FIG. 6 is an exploded view of the modular grow house system, detailing the assembly of various components including the electronics box with controller/IO or microcontroller, cooling fan, heater fan, sensor holders, and temperature and humidity sensor according to the embodiments of the present disclosure.

FIG. 7 is a rear perspective view of the modular grow house system, highlighting the back panel, heater case, cooling fan case, and the crate according to the embodiments of the present disclosure.

FIG. 8 is a section view of the modular grow house system taken along line 5-5 in FIG. 7. It shows the internal arrangement of components including the microcontroller, O2 sensor, moisture sensors, and floor panel according to the embodiments of the present disclosure.

FIG. 9 is a perspective view of an array of the modular grow house systems, demonstrating the scalability and modularity of the design, allowing for horizontal and vertical configuration to mimic the footprint according to the embodiments of the present disclosure.

The drawings described herein are for illustration purposes only and are not intended to limit the scope of the present subject matter in any way.

### DETAILED DESCRIPTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

The present invention addresses the significant limitations inherent in traditional greenhouses and existing controlled environment agriculture (CEA) technologies, which adversely affect their effectiveness and accessibility, particularly in urban and resource-constrained settings. These conventional systems often necessitate substantial initial capital expenditures and ongoing operational costs, rendering them less viable for small-scale and urban agricultural operations. Moreover, these systems typically depend on manual adjustments to sustain optimal growing conditions, which are labor-intensive, inconsistent, and susceptible to human error. The lack of modularity and scalability in current systems impedes their ability to accommodate various plant species, growth stages, and spatial configurations. Furthermore, existing solutions frequently fail to incorporate advanced automation and monitoring technologies, resulting in inefficient resource utilization and suboptimal plant growth conditions. Collectively, these deficiencies constrain the productivity and sustainability of traditional agricultural practices, thereby underscoring the necessity for an innovative solution that effectively addresses these challenges.

The present invention provides a modular grow house system designed to optimize the cultivation of various types of vegetation through advanced environmental control, effectively addressing the limitations of traditional greenhouses and existing controlled environment agriculture (CEA) technologies. The system comprises a plurality of grow chambers, each equipped with a set of sensors configured to monitor environmental conditions and a set of actuators configured to regulate these conditions. Central to the system is a control unit that manages the environmental conditions within each grow chamber. This control unit includes a receiving unit for plant profile information, a monitoring unit to gather real-time data from the sensors, a processing unit to determine optimal environmental conditions based on the plant profiles and real-time data, and a regulating unit to instruct the actuators to adjust the environmental parameters accordingly. Plant parameters are stored in digital formats, such as JSON files, within an SD card module. These parameters are parsed by a primary controller, which correlates them to the appropriate sensor readings and actuator controls, and then transmits the parsed parameters to a secondary controller, referred to as ControllerIO, for real-time adjustments within each grow chamber. This dynamic interaction ensures that the system maintains the optimal growing conditions necessary for various plant species, thereby enhancing plant growth and yield.

The modular grow house system is further designed with modular elements that enable flexible configuration and expansion both vertically and horizontally, allowing for adaptation to different spatial requirements and specific user needs. The system incorporates interchangeable panels, standardized mounting brackets for sensors and actuators, quick-connect fittings for water and electrical connections, and expandable frame structures, facilitating easy assembly, disassembly, and reconfiguration. This design enables the system to mimic its footprint in both vertical and horizontal expansions. Additionally, the system integrates safety features, such as temperature and humidity alarms, and provides real-time alerts and notifications based on deviations from optimal environmental conditions. The control unit is configured to receive remote updates via a cloud platform, ensuring that plant profile information and control algorithms remain current. This comprehensive approach, emphasizing the modularity and adaptability of the system, allows it to independently monitor and adjust conditions within each grow chamber, supporting the simultaneous cultivation of multiple types of vegetation and significantly improving the productivity and sustainability of agricultural practices.

The modular grow house system is composed of a plurality of interconnected grow chambers, each designed with a structural frame constructed from durable aluminum extrusions that provide robust support while allowing for flexible configuration. The chambers are enclosed by clear scratch and UV-resistant sheets, which protect the internal environment and ensure sufficient light penetration. The modular design includes interchangeable panels, standardized mounting brackets for sensors and actuators, and quick-connect fittings for water and electrical connections, all of which facilitate easy assembly, disassembly, and reconfiguration. The system also features expandable frame structures, enabling both vertical and horizontal expansion to mimic its footprint and adapt to different spatial requirements. Each grow chamber is equipped with a set of sensors, including temperature sensors, humidity sensors, light sensors, and soil moisture sensors, as well as a set of actuators such as cooling fans, venting fans, water pumps, misting devices, and LED lighting fixtures. These components are centrally managed by a control unit housed within an electronics box, which processes data, stores plant profiles, and coordinates the operation of sensors and actuators to maintain optimal growing conditions within each chamber.

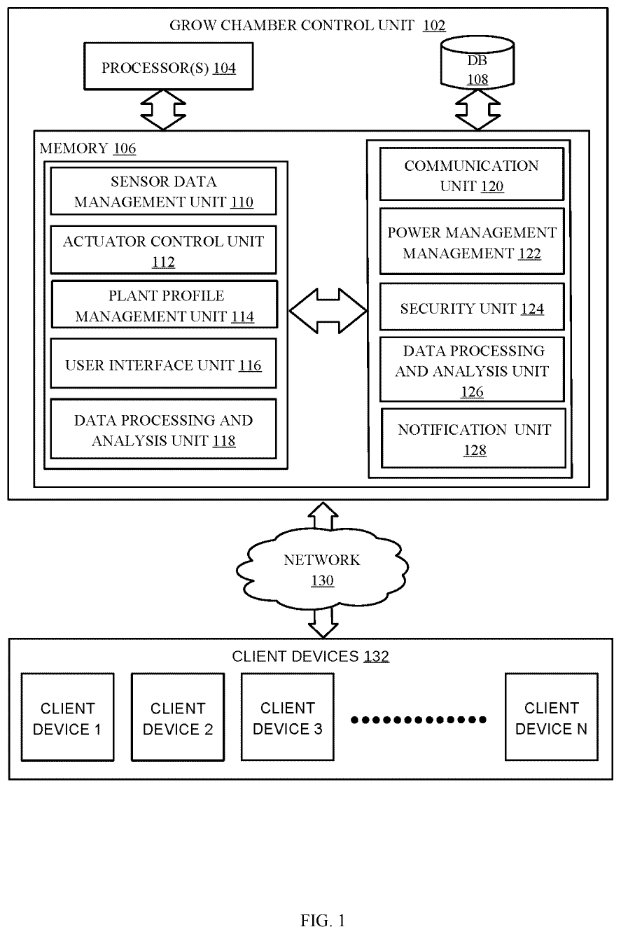

Referring to the figures, FIG. 1 illustrates the detailed architecture of the Grow Chamber Control Unit 102, which is the central hub for managing the environmental conditions within the modular grow house system. At the heart of this unit are the Processor(s) 104, responsible for executing the system's software instructions and coordinating the activities of various components. The Memory 106, connected to the processor, stores essential data and software modules required for the operation of the grow house system. A database (DB) 108 is provided to store data and may include an SD card or other storage means.

The Sensor Data Management Unit 110 is tasked with collecting, processing, and interpreting data from various sensors distributed throughout the grow chambers. These sensors include temperature sensors, humidity sensors, light sensors, and soil moisture sensors, which provide real-time data on the environmental conditions within each chamber. The Actuator Control Unit 112 is responsible for controlling the actuators based on the processed sensor data. Actuators managed by this unit include cooling fans, venting fans, water pumps, misting devices, and LED lighting fixtures. These actuators work in tandem to maintain the optimal growing conditions as dictated by the sensor data and plant profiles.

Central to the functionality of the control unit is the Plant Profile Management Unit 114, which stores and manages detailed profiles for different plant species. These profiles include optimal growth parameters such as temperature range, humidity range, light intensity, duration, soil moisture levels, and nutrient delivery schedules. The User Interface Unit 116 provides an interface for users to interact with the system. Through this unit, users can input plant profiles, monitor system performance, and manually override automated controls if necessary. This unit ensures that the system remains user-friendly and accessible.

The Data Processing and Analysis Unit 118 is crucial for interpreting the vast amount of data collected by the sensors. It processes this data in conjunction with the plant profiles to determine the optimal environmental conditions for each grow chamber. This unit uses algorithms and data analysis techniques to make precise adjustments to the actuators. The Communication Management Unit 120 handles all data communications between the control unit and external devices, ensuring that the system can receive and send data seamlessly. This unit enables the integration of external data sources and the dissemination of system alerts and updates.

The Power Management Unit 122 ensures that all components of the grow house system receive a stable and sufficient power supply, adjusting power distribution as necessary to maintain system stability and efficiency. The Security Unit 124 adds a layer of protection to the system, incorporating features such as password protection and biometric access control to prevent unauthorized access and ensure data integrity. The Notification Unit 126 is responsible for generating alerts and notifications when the environmental conditions deviate from the optimal settings. This unit ensures that users are promptly informed of any issues that require intervention. Additionally, the control unit can connect to multiple client devices 130, allowing users to access and control the system remotely. This connectivity is facilitated through a network interface, which supports communication with external servers and devices for updates, monitoring, and control.

The architecture of the Grow Chamber Control Unit 102 integrates multiple specialized units to provide a comprehensive solution for managing and optimizing the growing conditions within the modular grow house system. Each component works in concert to ensure that various types of vegetation receive the precise care they need to thrive.

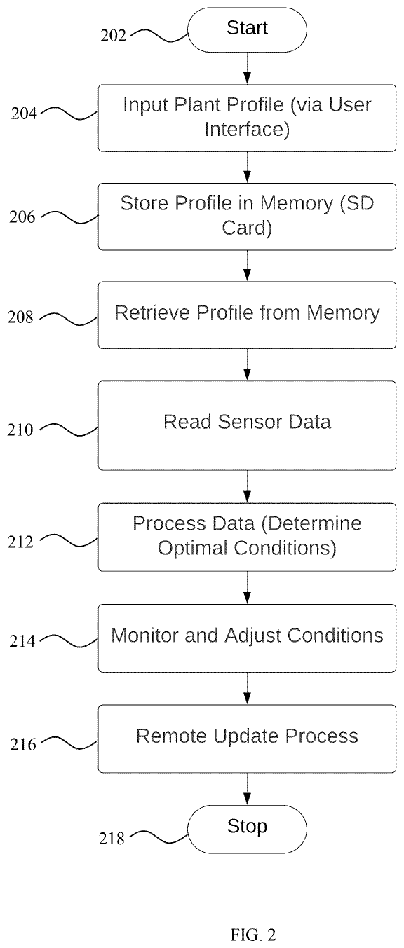

FIG. 2 provides a detailed flowchart depicting the control process within the modular grow house system. This flowchart outlines the sequence of operations performed by the system to maintain optimal growing conditions within the grow chambers, starting from the user input of plant profiles to the continuous monitoring and adjustment of environmental conditions.

The process begins at step 202, which marks the start of the control process. Following this, step 204 involves the input of the plant profile via the user interface. In this step, users provide essential information about the plant species to be cultivated, including parameters such as optimal temperature, humidity, light intensity, and soil moisture levels. This data is crucial for tailoring the environmental conditions within the grow chambers to the specific needs of the plants.

Once the plant profile is inputted, the process moves to step 206, where the profile is stored in the system's storage, specifically on an SD card. This ensures that the plant profile data is securely saved and can be retrieved whenever needed. The use of an SD card allows for easy updates and modifications to the plant profiles as new information becomes available or as user needs change.

In step 208, the stored plant profile is retrieved from the storage. This step is essential for the subsequent operations, as the retrieved profile contains the necessary data to guide the control and adjustment of the environmental conditions within the grow chambers. The process then moves to step 210, where sensor data is read. Sensors distributed throughout the grow chambers collect real-time data on various environmental parameters, including temperature, humidity, light levels, and soil moisture. This data is critical for understanding the current conditions within the chambers.

Step 212 involves processing the collected data to determine the optimal conditions for the plants based on the retrieved plant profile and the real-time sensor data. During this step, the control unit uses algorithms and data analysis techniques to compare the current environmental conditions with the optimal conditions specified in the plant profile. Adjustments are made as necessary to align the actual conditions with the desired parameters.

Following the determination of optimal conditions, step 214 entails monitoring and adjusting the conditions within the grow chambers. The control unit sends control signals to various actuators, such as cooling fans, venting fans, water pumps, misting devices, and LED lighting fixtures, to modify the environment. These actuators work in concert to ensure that the environmental conditions remain within the optimal ranges specified by the plant profiles.

The flowchart also includes step 216, which represents the remote update process. This step allows the system to receive updates from remote servers, ensuring that the plant profiles and control algorithms are always up to date. This capability is vital for incorporating new research findings and adjusting to changing user needs.

Finally, the process concludes at step 218, marking the stop of the control process. However, it is important to note that the system operates continuously in a loop, constantly monitoring and adjusting the environmental conditions to ensure optimal growing conditions for the plants. This detailed flowchart in FIG. 2 highlights the systematic approach taken by the modular grow house system to manage and optimize the growing environment, ensuring the health and productivity of various types of vegetation.

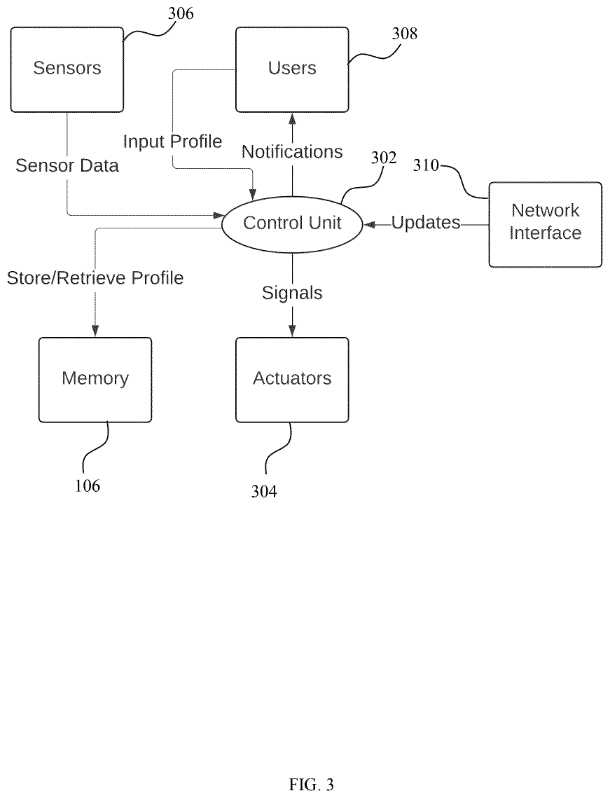

FIG. 3 illustrates the data flow within the modular grow house system, showing the interactions between the User Interface 302, Memory 106, Sensors 304, Actuators 306, and Network Interface 308. This figure provides a comprehensive overview of how data moves through the system to ensure optimal environmental conditions for the plants.

At the top of the diagram, we have the User Interface 302, which is the primary point of interaction for users. Users input plant profiles through this interface, specifying the optimal growing conditions for different plant species. The User Interface 302 also receives notifications and alerts, keeping users informed about the status of the grow chambers and any deviations from the optimal conditions.

Data from the User Interface 302 flows to the Memory 106, where the plant profiles are stored. This memory securely holds the profiles, ensuring they are readily accessible for future use. The stored profiles include crucial information such as temperature range, humidity range, light intensity, soil moisture levels, and nutrient delivery schedules.

The Sensors 304 distributed throughout the grow chambers play a vital role in the system. These sensors continuously monitor various environmental parameters, including temperature, humidity, light levels, and soil moisture. The sensor data is then sent to the Control Unit 310, where it is stored in the Sensor Data Storage 312.

The Control Unit 310 processes the sensor data and retrieves the relevant plant profiles from the Memory 106. The processing involves comparing the real-time sensor data with the parameters specified in the plant profiles. This comparison helps in determining whether the current environmental conditions are within the optimal ranges or if adjustments are necessary.

Based on the processed data, the Control Unit 310 sends control signals to the Actuators 306. These actuators include cooling fans, venting fans, water pumps, misting devices, and LED lighting fixtures. The control signals instruct the actuators to adjust the environmental conditions as needed to maintain the optimal settings for plant growth. For instance, if the temperature sensor indicates that the temperature is too high, the Control Unit 310 might activate the cooling fans to lower the temperature.

The Actuators 306 also provide feedback to the Control Unit 310, confirming that the instructed actions have been carried out. This feedback loop ensures that the system can verify the execution of control signals and make further adjustments if necessary.

The Network Interface 308 facilitates communication between the Control Unit 310 and remote servers. This interface handles updates and remote monitoring, allowing the system to receive new plant profiles, software updates, and other essential data from external sources. The Network Interface 308 also sends data to the remote servers, providing updates on the status of the grow chambers and any changes made to the environmental conditions.

Finally, the Control Unit 310 sends notifications and alerts back to the User Interface 302. These notifications keep the user informed about the system's status, including any deviations from the optimal conditions and the actions taken to address them. Users can then take further action if required, such as adjusting the plant profiles or manually intervening in the control processes.

In summary, FIG. 3 provides a detailed view of the data flow within the modular grow house system, highlighting the interactions between the User Interface 302, Memory 106, Sensors 304, Actuators 306, and Network Interface 308. This integrated approach ensures that the system can continuously monitor and adjust the environmental conditions within the grow chambers, providing an optimal environment for various types of vegetation.

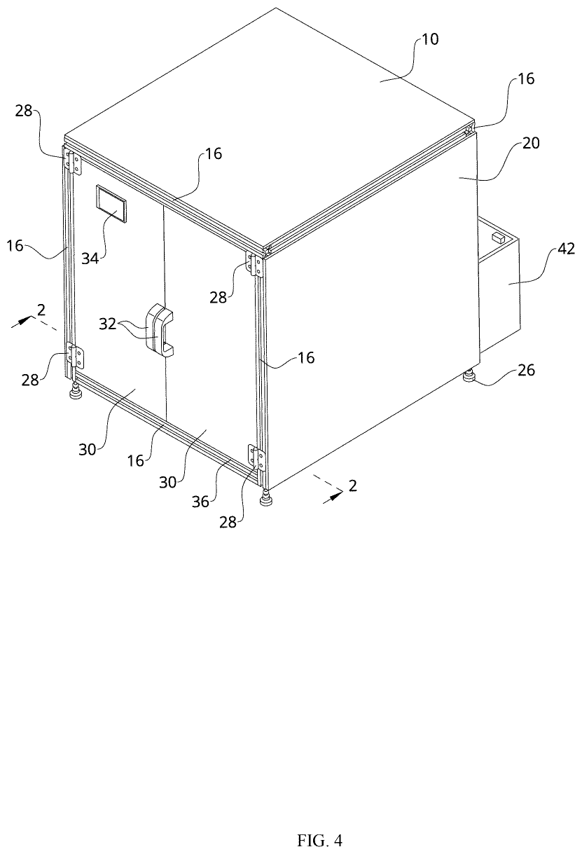

FIG. 4 is a perspective view of the modular grow house system, illustrating the overall design and structure. This figure showcases the components that form the basis of the grow house and their interconnections, demonstrating how they work together to provide an optimal growing environment for vegetation.

The figure features a structural frame constructed from aluminum extrusions (16). providing a robust and flexible foundation for the grow house. The frame is enclosed by clear scratch and UV-resistant sheets and includes several key components to maintain the internal environment.

The roof panel 10 and ceiling panel 12 form the top of the structure, with a ceiling fan 14 attached to regulate air circulation and maintain a stable internal climate. The grow house is supported by 90 brackets 18 that reinforce the aluminum extrusions 16. Side panels 20 enclose the sides of the grow house, and doors 30 fitted with handles 32 allow easy access to the interior. The doors are mounted on hinges 28, enabling them to open and close smoothly. The floor panel 36 completes the enclosure, providing a base for the structure.

Inside the chambers, drip rails 24 are installed to manage water distribution, and float pegs 26 provide support for the plants. Light strips 22 are positioned along the sides of the chambers, ensuring that the plants receive adequate illumination from the LED lighting fixtures. The electronics box 40 housing the controllerIO or microcontroller is prominently featured, responsible for managing the environmental conditions within the grow house. This control unit processes data from the sensors and coordinates the actuators to maintain optimal growing conditions.

Additionally, the figure shows the modular design elements, including interchangeable panels, standardized mounting brackets, and quick-connect fittings for water and electrical connections. These features facilitate easy assembly, disassembly, and reconfiguration, allowing the grow house system to adapt to different spatial requirements and plant types. The cooling fan 44 and its case 46 are also depicted, illustrating the system's capability to regulate temperature efficiently. The overall design ensures that the modular grow house system can create and maintain optimal growing environments for various types of vegetation, enhancing productivity and sustainability in agricultural practices.

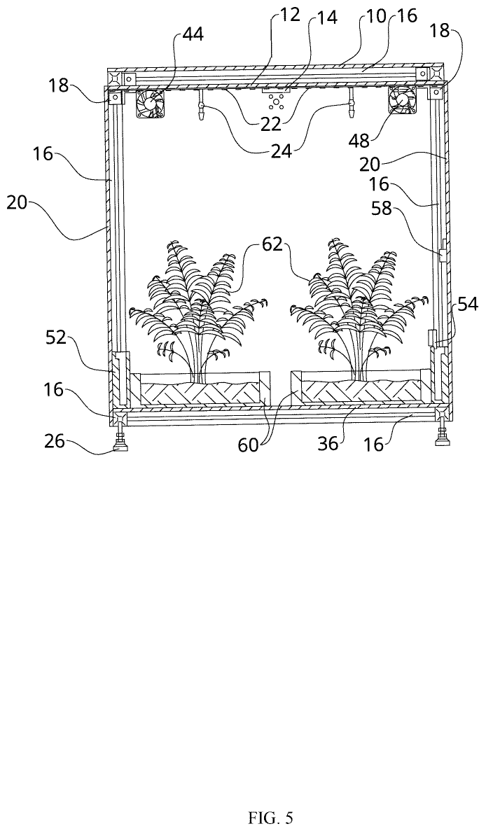

FIG. 5 is a section view of the modular grow house system taken along line 2-2 in FIG. 4, revealing the internal components and their arrangement within the grow house. This figure highlights how the various parts work together to maintain optimal growing conditions.

At the top of the structure, the ceiling panel 12 supports the ceiling fan 14, which is crucial for regulating air circulation and maintaining a stable internal climate. The aluminum extrusions 16 provide a robust and flexible framework that supports the entire structure. The side panels 20 and back panel 38 enclose the sides and rear of the grow house, respectively, ensuring that the internal environment remains controlled and protected from external elements.

Inside the grow chambers, drip rails 24 are installed to manage water distribution, ensuring that water is evenly distributed to the plants. Float pegs 26 support the plants and maintain their positioning within the chambers. Planters 60 are positioned within the chambers to hold the plants 62, allowing them to grow under optimal conditions.

The temperature and humidity sensor 56 is strategically placed within the chamber to monitor these critical environmental parameters. This sensor provides real-time data to the control unit housed within the electronics box 40, which processes the information and adjusts the actuators accordingly. Light strips 22 are positioned along the sides of the chambers to provide adequate illumination for the plants, simulating natural light conditions necessary for photosynthesis and growth. The cooling fan 44 is also depicted, highlighting its role in maintaining the appropriate temperature within the grow chambers.

Additionally, the figure illustrates the placement of the display with SD card 34, which is used for inputting plant profiles and monitoring the system's status. The display allows users to interact with the system, providing a user-friendly interface for managing the grow house environment. Overall, FIG. 5 demonstrates the internal configuration of the modular grow house system, showcasing how the various components work together to create and maintain optimal growing conditions for the plants.

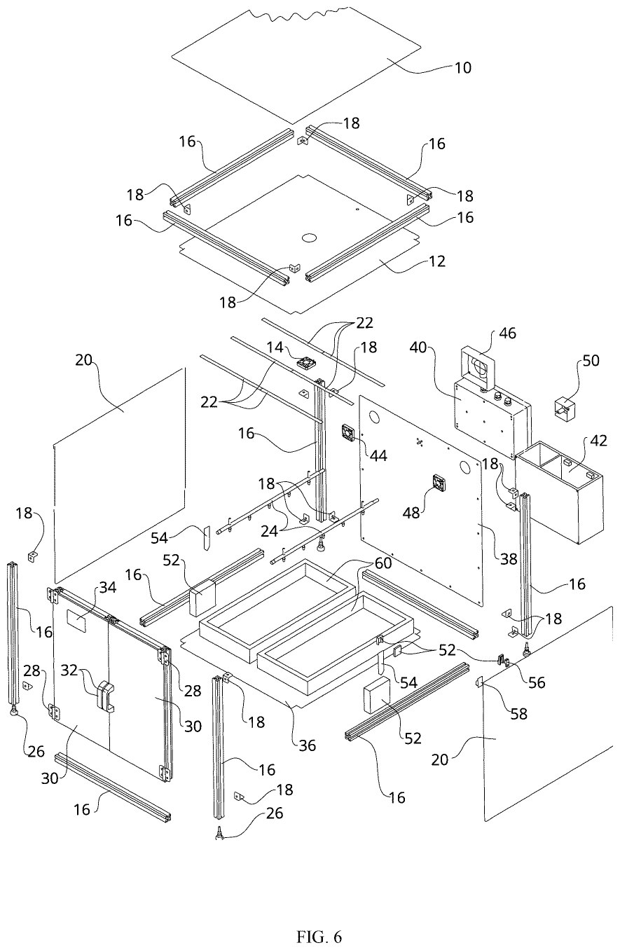

FIG. 6 is an exploded view of the modular grow house system, detailing the assembly of various components and how they fit together to form the complete structure. This figure provides a comprehensive look at the individual parts and their interconnections, illustrating the modularity and ease of assembly inherent in the design.

At the top of the structure, the roof panel 10 covers the grow house, supported by the aluminum extrusions 16 that form the structural frame. The ceiling panel 12 is attached beneath the roof panel, with the ceiling fan 14 mounted on it to regulate air circulation within the grow house.

The side panels 20 are shown, which attach to the aluminum extrusions 16 to enclose the sides of the grow house. These panels are secured using 90 brackets 18, which provide additional stability and support. The floor panel 36 is positioned at the base of the structure, completing the enclosure and providing a stable foundation for the grow house.

The back panel 38 is depicted, which closes off the rear of the grow house, ensuring that the internal environment is well-protected. The electronics box 40 is shown mounted on the back panel, housing the controller or microcontroller that manages the environmental conditions within the grow chambers. This control unit processes data from the sensors and coordinates the actuators to maintain optimal growing conditions.

The display with SD card 34 is also illustrated, providing a user interface for inputting plant profiles and monitoring the system's status. This display is connected to the control unit, allowing users to interact with the system and manage the grow house environment effectively.

The light strips 22 are shown positioned along the sides of the chambers, ensuring that the plants receive adequate illumination from the LED lighting fixtures. The cooling fan 44 and its case 46 are depicted, highlighting their role in regulating the temperature within the grow chambers.

Drip rails 24 and float pegs 26 are included in the assembly, managing water distribution and supporting the plants within the chambers. Planters 60 are positioned within the chambers to hold the plants 62, ensuring they are properly situated for optimal growth.

The heater fan 48 and heater case 50 are also illustrated, indicating their role in maintaining the appropriate temperature within the grow house. Sensor holders 52 are shown, which secure the moisture sensors 54 and the temperature and humidity sensor 56 within the chambers. These sensors provide real-time data to the control unit, allowing it to adjust the actuators accordingly.

The O2 sensor 58 is depicted, monitoring the oxygen levels within the grow chambers to ensure that the plants have the necessary atmospheric conditions for growth. The modular design elements, including quick-connect fittings and standardized mounting brackets, are shown, facilitating easy assembly, disassembly, and reconfiguration of the grow house system.

FIG. 6 provides a detailed view of the modular grow house system's components and their assembly, illustrating the modularity, flexibility, and ease of construction that characterize the design. This comprehensive approach ensures that the system can be easily adapted to different spatial requirements and plant types, enhancing productivity and sustainability in agricultural practices.

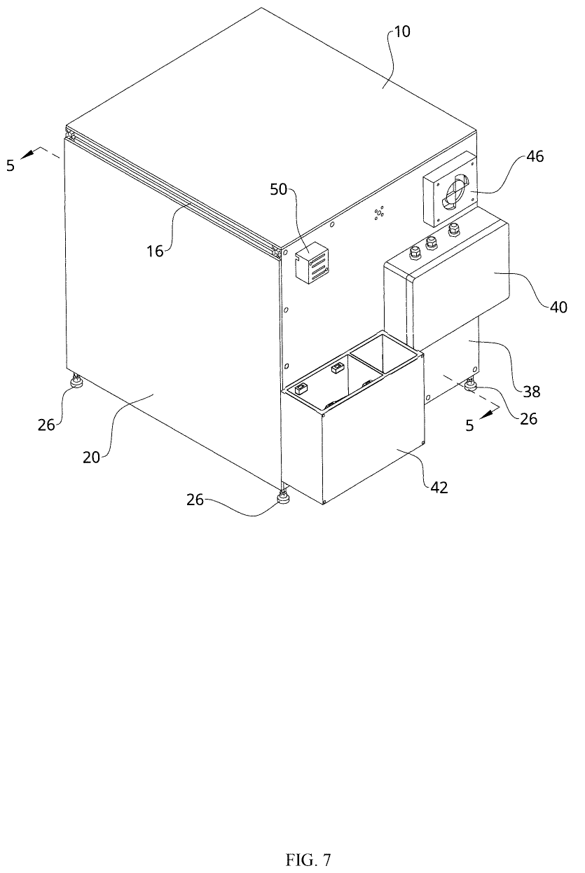

FIG. 7 is a rear perspective view of the modular grow house system, highlighting the back panel and various components attached to it, illustrating the configuration and role of these components in maintaining optimal environmental conditions within the grow house.

The back panel 38 is a critical structural element that closes off the rear of the grow house, ensuring the internal environment is well-protected from external elements. Mounted on this back panel is the electronics box 40, which houses the controllerIO or microcontroller responsible for managing the environmental conditions within the grow chambers. This control unit processes data received from the sensors and coordinates the actuators to maintain the optimal growing conditions necessary for the plants.

The cooling fan 44 and its case 46 are prominently shown in this figure. The cooling fan is crucial for regulating the temperature within the grow chambers by providing necessary airflow. The cooling fan case ensures that the fan is securely mounted and protected.

The heater fan 48 and heater case 50 are also depicted, highlighting their role in maintaining the appropriate temperature within the grow house. The heater fan provides warmth when needed, and the heater case protects the fan and ensures its efficient operation.

The crate 42 is shown at the base of the structure, providing additional support and stability for the grow house system. This crate may also be used for storage or housing additional components if necessary.

The rear perspective view also shows the positioning of various sensors and actuators within the grow house. The temperature and humidity sensor 56 is mounted within the chamber to continuously monitor these critical environmental parameters. Moisture sensors 54 are positioned to gauge the soil moisture levels, providing real-time data to the control unit.

The O2 sensor 58 is depicted, which monitors the oxygen levels within the grow chambers to ensure that the plants have the necessary atmospheric conditions for optimal growth. Sensor holders 52 secure these sensors in place, ensuring accurate and stable readings.

Drip rails 24 and float pegs 26 are included in the setup, managing water distribution and supporting the plants within the chambers. Planters 60 are shown within the chambers, holding the plants 62 and ensuring they are positioned correctly for optimal growth.

The modular design elements, including quick-connect fittings and standardized mounting brackets, facilitate easy assembly, disassembly, and reconfiguration of the grow house system. These features allow the system to adapt to different spatial requirements and plant types, enhancing its versatility and effectiveness. FIG. 7 provides a detailed view of the rear components and their configuration, illustrating how they work together to maintain optimal environmental conditions within the modular grow house system. This comprehensive approach ensures that the system can independently monitor and adjust conditions within each grow chamber, supporting the simultaneous cultivation of multiple types of vegetation.

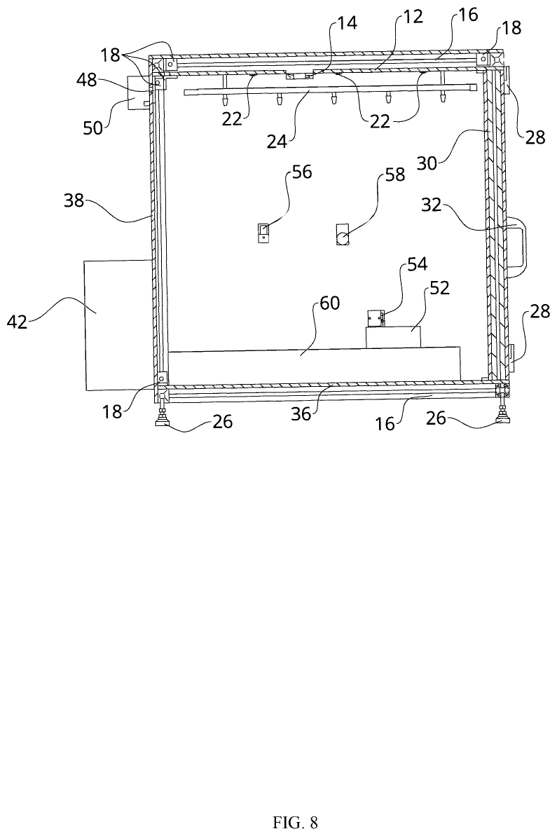

FIG. 8 is a section view of the modular grow house system taken along line 5-5 in FIG. 7, providing a detailed look at the internal arrangement of components and their roles in maintaining optimal environmental conditions within the grow house.

The section view illustrates the positioning and integration of the ceiling panel 12 and ceiling fan 14, which work together to regulate air circulation and maintain a stable internal climate. The ceiling fan ensures that air flows evenly throughout the grow chambers, preventing hot or cold spots and maintaining a consistent temperature.

The aluminum extrusions 16 form the structural framework of the grow house, providing durability and flexibility. These extrusions support the side panels 20 and the back panel 38, which enclose the structure and protect the internal environment from external elements. The floor panel 36 completes the enclosure, providing a solid foundation for the grow house.

The electronics box 40, which houses the control unit, is prominently shown in this figure. This control unit is responsible for managing the environmental conditions within the grow chambers by processing data from various sensors and coordinating the actuators. The electronics box is securely mounted on the back panel 38 to ensure easy access for maintenance and updates.

The temperature and humidity sensor 56 is strategically placed within the chamber to monitor these critical environmental parameters. The sensor provides real-time data to the control unit, which uses this information to make necessary adjustments to the actuators, such as the cooling fan 44 and heater fan 48, to maintain optimal growing conditions.

Moisture sensors 54 are positioned within the chambers to monitor soil moisture levels. These sensors ensure that the plants receive the right amount of water, preventing both overwatering and underwatering. The O2 sensor 58 monitors the oxygen levels within the grow chambers, ensuring that the plants have the necessary atmospheric conditions for growth.

The section view also highlights the placement of the display with SD card 34, which provides a user interface for inputting plant profiles and monitoring the system's status. This display is connected to the control unit, allowing users to interact with the system and manage the grow house environment effectively. In another embodiment, the user may be allowed to provide inputs remotely via client device 132 which may include any electronic device connected to the grow house control system 102 via network 130. In one example, instead of the SD card, the data may be stored in a cloud-based storage.

Drip rails 24 and float pegs 26 are included in the setup, managing water distribution and supporting the plants within the chambers. Planters 60 are shown holding the plants (62), ensuring they are positioned correctly for optimal growth. The light strips 22 are depicted along the sides of the chambers, providing adequate illumination from the LED lighting fixtures to simulate natural light conditions necessary for photosynthesis. FIG. 8 provides a comprehensive view of the internal arrangement and integration of components within the modular grow house system. This detailed illustration showcases how the various parts work together to create and maintain optimal growing environments for different types of vegetation, enhancing productivity and sustainability in agricultural practices.

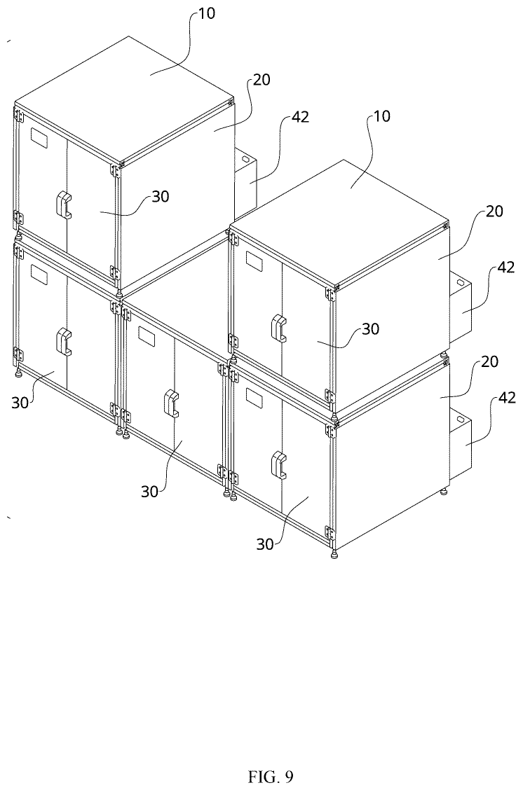

FIG. 9 is a perspective view of an array of the modular grow house systems, demonstrating the scalability and modularity of the design. This figure illustrates how multiple grow house units can be configured both vertically and horizontally, showcasing the system's adaptability to different spatial requirements and enabling efficient use of available space.

The grow houses are constructed using aluminum extrusions 16, which form the robust and flexible framework for each unit. The modular design allows for easy assembly and disassembly, facilitating the stacking and expansion of multiple units. This feature is particularly useful for urban agriculture or environments with limited space, where maximizing the growing area is crucial.

The figure shows how the roof panels 10, side panels 20, and back panels 38 of each grow house unit fit together seamlessly, creating a continuous and integrated structure. The floor panels 36 of the upper units are supported by the roof panels 10 of the lower units, ensuring stability and structural integrity.

Each grow house unit is equipped with the same set of sensors and actuators as described in the previous figures, including temperature and humidity sensors 56, moisture sensors 54, O2 sensors 58, cooling fans 44, venting fans 26, water pumps 28, misting devices 30, and LED lighting fixtures 22. These components are centrally managed by the control unit housed within the electronics box 40 in each unit, ensuring that optimal growing conditions are maintained independently within each grow chamber.

The modular design also includes interchangeable panels 20, standardized mounting brackets 18, and quick-connect fittings for water and electrical connections, facilitating the reconfiguration of the grow house units as needed. This flexibility allows users to adapt the system to different plant species, growth stages, and spatial configurations.

The light strips 22 are shown providing consistent illumination across all units, ensuring that the plants receive adequate light for photosynthesis regardless of their position within the array. The cooling fans 44 and venting fans 26 are strategically placed to maintain proper air circulation and temperature control throughout the entire system.

Additionally, the figure highlights the user interfaces 34 on each grow house unit, which allow users to input plant profiles, monitor environmental conditions, and manage the system effectively. These interfaces are connected to the control units, enabling seamless communication and coordination between the units.

Overall, FIG. 9 demonstrates the modular grow house system's scalability and adaptability, showcasing its ability to expand both vertically and horizontally to meet various spatial and agricultural needs. This innovative design enhances the productivity and sustainability of agricultural practices, making it suitable for a wide range of applications, particularly in urban and resource-constrained settings.

Components of the control unit of the modular grow house system may be any combination of hardware and programming to implement the functionalities described herein. In some implementations, the programming may be processor-executable instructions stored on a non-transitory machine-readable storage medium (e.g., memory), and the hardware may include at least one processing resource to retrieve and/or execute those instructions. Processor(s) 104 may include, but are not limited to, one or more digital signal processors (DSPs), one or more microprocessors, one or more special-purpose computer chips, one or more field-programmable gate arrays (FPGAs), one or more application-specific integrated circuits (ASICs), one or more system-on-chip (SoC) designs, one or more computers, various analog-to-digital converters, digital-to-analog converters, and/or other support circuits. Processor(s) may also include the functionality to encode messages and/or data or information. Processor(s) may include, among other things, a clock, an arithmetic logic unit (ALU), and logic gates configured to support the operation of processor(s). Further, the processor(s) may include functionality to execute one or more software programs, which may be stored in the memory or otherwise accessible to processor(s).

Memory 106 may store any number of pieces of information and data used by the system to implement its functions. The memory 106 may include, for example, volatile memory and/or non-volatile memory. Examples of volatile memory may include, but are not limited to, random-access memory (RAM). The non-volatile memory may additionally or alternatively comprise electrically erasable programmable read-only memory (EEPROM), flash memory, solid-state drives (SSDs), hard drives, and the like. Some examples of volatile memory include, but are not limited to, dynamic RAM, static RAM, and the like. Some examples of non-volatile memory include, but are not limited to, hard disks, magnetic tapes, optical disks, programmable read-only memory, erasable programmable read-only memory, electrically erasable programmable read-only memory, flash memory, and the like. Memory may be configured to store information, data, applications, instructions, or the like for enabling the system to carry out various functions in accordance with various example embodiments. Additionally, or alternatively, the memory may be configured to store instructions which, when executed by processor(s), cause the grow house system to behave in a manner as described in various embodiments.

In one implementation, the network 130 may be a wireless network, a wired network, or a combination thereof. The network 130 may be implemented as one of several types of networks, such as an intranet, local area network (LAN), wide area network (WAN), the internet, mesh networks, cellular networks (4G, 5G), satellite networks, and the like. The network may either be a dedicated network or a shared network. The shared network represents an association of several types of networks that use a variety of protocols, for example, Hypertext Transfer Protocol (HTTP), Transmission Control Protocol/Internet Protocol (TCP/IP), Wireless Application Protocol (WAP), Bluetooth, Zigbee, LoRaWAN, and the like, to communicate with one another. Further, the network 130 may include a variety of network devices, including routers, bridges, gateways, servers, computing devices, storage devices, and the like.

The modular grow house system leverages advanced data management techniques to optimize the cultivation environment for various types of vegetation. Central to this innovation is the use of JSON (JavaScript Object Notation) formatted files and the integration of an SD card for data storage and retrieval. These elements play a crucial role in the seamless operation and adaptability of the system.

JSON is a lightweight data interchange format that is easy for humans to read and write, and for machines to parse and generate. In the context of the modular grow house system, JSON files are used to store detailed plant profiles. Each plant profile includes essential parameters for optimal growth, such as temperature range, humidity range, light intensity, soil moisture levels, and nutrient delivery schedules. The use of JSON allows for the structured representation of this data, making it straightforward to update, modify, and transfer plant profiles. When a user inputs a new plant profile via the User Interface, the system generates a corresponding JSON file that encapsulates all the required growth parameters.

The SD card serves as the primary storage medium for these JSON files. It provides a reliable and flexible means of storing large amounts of data, ensuring that all plant profiles are securely saved and easily accessible. The SD card's portability also allows users to transfer plant profiles between different grow house systems or update the profiles as new data becomes available. When the system needs to retrieve a plant profile, it reads the relevant JSON file from the SD card. The Control Unit then parses the JSON file to extract the necessary parameters, which are used to adjust the environmental conditions within the grow chambers.

The integration of the SD card and JSON files enables the modular grow house system to be highly adaptable and user-friendly. Users can easily update plant profiles by simply modifying the JSON files and reloading them onto the SD card. This flexibility ensures that the system can accommodate a wide range of plant species and adapt to evolving agricultural practices. Additionally, the use of standardized JSON formatting facilitates compatibility with other software tools and systems, allowing for seamless integration and data exchange.

Furthermore, the system's ability to process and parse JSON files in real-time ensures that the environmental conditions within the grow chambers are continuously optimized based on the most current data. This dynamic adjustment capability is critical for maintaining optimal growing conditions and maximizing plant health and productivity. Overall, the use of JSON and SD card storage is a key technological advancement that enhances the functionality, flexibility, and efficiency of the modular grow house system.

While the use of JSON files and SD cards provides an effective means of managing plant profiles and data storage in the modular grow house system, alternative embodiments can offer similar functionality with different technologies. These alternatives can cater to various user needs and technological preferences, ensuring flexibility and adaptability of the system.

One alternative to using JSON files for storing plant profiles is the adoption of XML (extensible Markup Language) files. XML is another widely-used data interchange format that supports complex data structures. Like JSON, XML files can store detailed plant profiles, including parameters for temperature, humidity, light intensity, soil moisture levels, and nutrient schedules. XML's hierarchical structure allows for clear organization of data, making it easy to read and write by both humans and machines. The use of XML files can be particularly advantageous in environments where compatibility with existing XML-based systems is required.

Another alternative data storage format is CSV (Comma-Separated Values) files. CSV files are simpler than JSON and XML, storing data in a tabular format. Each line in a CSV file represents a plant profile, with individual parameters separated by commas. This format is highly compatible with spreadsheet software, making it easy for users to view and edit plant profiles using common tools like Microsoft Excel or Google Sheets. The simplicity of CSV files can also lead to faster processing times, which might be beneficial in systems where rapid data retrieval and updates are necessary.

In terms of data storage alternatives to SD cards, cloud-based storage solutions can offer significant advantages. By leveraging cloud storage, plant profiles and environmental data can be stored on remote servers accessible via the internet. This approach allows users to access and update their plant profiles from any location, providing greater flexibility and convenience. Cloud storage also supports automatic backups and data synchronization across multiple devices, ensuring data integrity and security. Furthermore, cloud-based solutions can facilitate real-time data sharing and collaboration among multiple users, making it easier to manage large-scale agricultural operations.

Another viable alternative is the use of internal solid-state drives (SSDs) or hard disk drives (HDDs) within the control unit. These storage devices can offer higher storage capacities and faster read/write speeds compared to SD cards. Internal storage solutions can be particularly useful in large-scale grow house systems where extensive data logging and storage are required. SSDs, in particular, provide high reliability and durability, making them suitable for continuous operation in demanding environments.

Additionally, USB flash drives can be used as an alternative to SD cards for portable data storage. USB flash drives offer similar portability and ease of use but may provide greater storage capacities and faster data transfer rates. They can be easily connected to the control unit via USB ports, allowing for quick and convenient updates to plant profiles and system data.

Overall, while JSON files and SD cards are effective for managing plant profiles and data storage in the modular grow house system, alternative embodiments such as XML and CSV files, cloud storage, internal SSDs or HDDs, and USB flash drives can provide similar functionalities with varying benefits. These alternatives ensure that the system can be tailored to meet different user needs and technological preferences, enhancing its flexibility and adaptability.

In conclusion, the modular grow house system represents a significant advancement in controlled environment agriculture, offering a flexible, scalable, and automated solution for optimizing plant growth. The system's architecture integrates a comprehensive array of components, including sensors, actuators, and a robust control unit, all working in harmony to maintain optimal growing conditions within each grow chamber. The innovative use of data storage formats such as JSON, XML, and CSV, along with various storage media options like SD cards, cloud storage, internal SSDs, HDDs, and USB flash drives, provides versatility and adaptability to meet diverse user requirements.

The control unit's ability to dynamically adjust environmental parameters based on real-time sensor data and predefined plant profiles ensures that each plant receives the precise care it needs to thrive. The inclusion of safety features, such as temperature and humidity alarms, alongside remote monitoring and update capabilities, further enhances the system's reliability and user convenience. The user interface facilitates easy interaction with the system, allowing for seamless input of plant profiles and manual overrides when necessary.

The modular design of the grow house system allows for vertical and horizontal expansion, accommodating different spatial configurations and enabling users to scale their operations as needed. This modularity, combined with the system's advanced control and data management capabilities, makes it an ideal solution for urban farming, research facilities, and commercial agricultural operations.

Moreover, the detailed descriptions of figures and the elucidation of various embodiments underscore the system's comprehensive and integrative approach to modern agriculture. By addressing the limitations of traditional greenhouses and existing controlled environment agriculture technologies, the modular grow house system sets a new standard for efficiency, productivity, and sustainability in plant cultivation.

This invention not only optimizes the growing environment for a wide variety of plant species but also offers a user-friendly, adaptable, and reliable platform that can significantly enhance the efficiency and effectiveness of agricultural practices. The detailed architecture and operational processes described herein highlight the innovative nature of the system, promising substantial benefits for both small-scale and large-scale agricultural endeavors.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A modular grow house system for cultivating vegetation, comprising:
a plurality of grow chambers comprising a set of sensors to monitor environmental conditions and a set of actuators to regulate the environmental conditions within each of the plurality of grow chambers; and
a control unit configured to manage the environmental conditions within each of the plurality of grow chambers, comprising:
a receiving unit to receive plant profile information for each of the plurality of grow chambers;
a monitoring unit to receive real-time data from the set of sensors provided within each of the plurality of grow chambers;
a processing unit to determine optimal environmental conditions for each of the plurality of grow chambers based on the received plant profile information and real-time data received from the group of sensors; and
a regulating unit to instruct the set of actuators to regulate the environmental conditions within each of the plurality of grow chambers to maintain the determined optimal environmental conditions within each of the plurality of grow chambers.

2. The modular grow house system of claim 1, wherein the plurality of grow chambers are interconnected.

3. The modular grow house system of claim 1, wherein the set of sensors include at least one of: a temperature sensors, humidity sensors, light sensors, and soil moisture sensors.

4. The modular grow house system of claim 1, wherein the set of actuators include at least one of: cooling fans, venting fans, water pumps, misting devices, and LED lighting fixtures.

5. The modular grow house system of claim 1, wherein the plant profile information comprises parameters for optimal growth of a plant, including temperature range, humidity range, light intensity and duration, soil moisture levels, nutrient delivery schedules, and growth stage-specific adjustments for each parameter.

6. The modular grow house system of claim 1, wherein the plant profile information is stored in a digital format, including but not limited to JSON, XML, or CSV files, within a memory module of the control unit.

7. The modular grow house system of claim 1, wherein each of the plurality of grow chambers are constructed with modular elements enabling flexible configuration and expansion, including interchangeable panels, standardized mounting brackets for sensors and actuators, quick-connect fittings for water and electrical connections, and expandable frame structures.

8. The modular grow house system of claim 1, further comprising safety features including temperature and humidity alarms to detect abnormal environmental conditions.

9. The modular grow house system of claim 1, wherein the processing unit is further configured to generate alerts or notifications based on deviations from the optimal environmental conditions as determined from the plant profiles and real-time sensor data.

10. The modular grow house system of claim 1, wherein the control unit is configured to allow users to remotely communicate with the system.

11. A method for cultivating vegetation in a modular grow house system, comprising the steps of:
configuring a plurality of grow chambers, each comprising a set of sensors to monitor environmental conditions and a set of actuators to regulate the environmental conditions within each of the plurality of grow chambers;
receiving plant profile information for each of the plurality of grow chambers through a receiving unit of a control unit;
receiving real-time data from the set of sensors within each of the plurality of grow chambers through a monitoring unit of the control unit;
determining optimal environmental conditions for each of the plurality of grow chambers based on the received plant profile information and real-time data from the set of sensors through a processing unit of the control unit; and
instructing the set of actuators to regulate the environmental conditions within each of the plurality of grow chambers to maintain the determined optimal environmental conditions through a regulating unit of the control unit.

12. The method of claim 11, further comprising the step of interconnecting the plurality of grow chambers.

13. The method of claim 11, wherein the set of sensors includes at least one of: temperature sensors, humidity sensors, light sensors, and soil moisture sensors.

14. The method of claim 11, wherein the set of actuators includes at least one of: cooling fans, venting fans, water pumps, misting devices, and LED lighting fixtures.

15. The method of claim 11, further comprising the step of storing plant profile information in a digital format, including but not limited to JSON, XML, or CSV files, within a memory module of the control unit.

16. The method of claim 11, further comprising the step of constructing each of the plurality of grow chambers with modular elements enabling flexible configuration and expansion, including interchangeable panels, standardized mounting brackets for sensors and actuators, quick-connect fittings for water and electrical connections, and expandable frame structures.

17. The method of claim 11, further comprising the step of activating safety features including temperature and humidity alarms to detect abnormal environmental conditions.

18. The method of claim 11, further comprising the step of generating alerts or notifications based on deviations from the optimal environmental conditions as determined from the plant profiles and real-time sensor data.

19. The method of claim 11, further comprising the step of allowing users to remotely communicate with the system through the control unit.
